(19) United States
(12) Patent Application Publication
(10) Pub. No.: US 2021/0294886 A1
(43) Pub. Date: Sep. 23, 2021

(54) CONTROL DEVICE AND SYSTEM

(71) Applicant: KABUSHIKI KAISHA TOKAI RIKA DENKI SEISAKUSHO, Aichi (JP)

(72) Inventors: Kyohei TAKEUCHI, Aichi (JP); Kenichi KOGA, Aichi (JP); Kohei KISHIMOTO, Aichi (JP)

(73) Assignee: KABUSHIKI KAISHA TOKAI RIKA DENKI SEISAKUSHO, Aichi (JP)

(21) Appl. No.: 17/186,419

(22) Filed: Feb. 26, 2021

(30) Foreign Application Priority Data
Mar. 23, 2020 (JP) 2020-051821

(51) Int. Cl. G06F 21/35; G06F 21/32

(52) U.S. Cl. CPC G06F 21/35; G06F 2221/2137; G06F 21/32

(57) ABSTRACT

To further improve security while assuring operability.

There is provided a control device comprising a control section configured to control a designated function on a basis of authenticity of a user and authenticity of a possession carried by the user, wherein the control section controls execution of the designated function in a case where the authenticity of the user is confirmed on a basis of first information acquired while the user is treated as a detection target and the authenticity of the possession is confirmed on a basis of second information acquired from the possession through wireless communication.

### CROSS REFERENCE TO RELATED APPLICATION(S)

This application is based upon and claims benefit of priority from Japanese Patent Application No. 2020-051821, filed on Mar. 23, 2020, the entire contents of which are incorporated herein by reference.

### BACKGROUND

The present invention relates to a control device and a system.

In recent years, technologies of performing authentication in accordance with a result of transmitting/receiving signals between devices have been developed. For example, JP H11-208419A discloses a system of authenticating a portable device by transmitting/receiving signals between an in-vehicle device and the portable device.

In the case of further improving security of the above-described system, it is assumed that an authentication method is additionally executed by using another information that is different from the signals transmitted/received between the devices, for example. However, in this case, there is a possibility that a user feels bothered by some types of information and some types of information input formats to be used.

Accordingly, the present invention is made in view of the aforementioned issue, and an object of the present invention is to further improve security while assuring operability.

### SUMMARY

To solve the above described problem, according to an aspect of the present invention, there is provided a control device comprising a control section configured to control a designated function on a basis of authenticity of a user and authenticity of a possession carried by the user, wherein the control section controls execution of the designated function in a case where the authenticity of the user is confirmed on a basis of first information acquired while the user is treated as a detection target and the authenticity of the possession is confirmed on a basis of second information acquired from the possession through wireless communication.

To solve the above described problem, according to another aspect of the present invention, there is provided a control device that is installed in a mobile object, the control device comprising a control section configured to control a designated function related to the mobile object, on a basis of authenticity of a user and authenticity of a possession carried by the user, wherein the control section controls execution of the designated function related to the mobile object, in a case where the authenticity of the user is confirmed on a basis of first information acquired by a sensor installed in the mobile object while the user is treated as a detection target and the authenticity of the possession is confirmed on a basis of second information acquired from the possession through wireless communication.

To solve the above described problem, according to another aspect of the present invention, there is provided a system comprising: a possession configured to be carried by a user; a control device configured to control a designated function related to a control target, on a basis of authenticity of the user and authenticity of the possession; and a sensor configured to be installed in the control target and acquire first information while the user is treated as a detection target, wherein the control device controls execution of the designated function in a case where the authenticity of the user is confirmed on a basis of the first information and the authenticity of the possession is confirmed on a basis of second information acquired from the possession through wireless communication.

As described above, according to the present invention, it is possible to further improve security while assuring operability.

### BRIEF DESCRIPTION OF THE DRAWINGS

FIG. 1 is a diagram illustrating a configuration example of a system 1 according to a first embodiment of the present invention.

FIG. 2 is a flowchart illustrating an example of a flow of operation of the system 1 according to the embodiment.

FIG. 3 is a diagram illustrating a configuration example of a server 80 according to a second embodiment of the present invention.

FIG. 4 is a flowchart illustrating an example of a flow of operation of the server 80 according to the embodiment.

FIG. 5 is a flowchart illustrating an example of a flow of operation of a server 80 according to a third embodiment of the present invention.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Background

First, a background of the present invention will be briefly described. In recent years, technologies of authenticating a user who instructs a device to execute a function of the device have been widespread. In addition, it is assumed that a plurality of different elements (pieces of information) of the user is required to further improve security. Such elements (pieces of information) are necessary for the authentication.

However, in the case where the user himself/herself has to intentionally perform operation of inputting the required information into a system, there is a possibility that operational load increases and the user feels bothered by some types of information input formats.

Therefore, to assure operability during the authentication process and further improve security, it is desirable to collect information for determining authenticity of the user without making the user particularly aware of the collection.

The technical idea of the present invention was conceived by focusing on the above-described points. Hereinafter, features of the present invention and effects achieved by the features will be described in detail.

Note that, hereinafter, the case where the technical idea of the present invention is applied to control over functions related to a mobile object such as a vehicle, will be described as a major example. However, the range of application of the technical idea of the present invention is not limited to such an example. The technical idea of the present invention is widely applicable to various kinds of systems of executing an authentication process when controlling over functions.

### 2. First Embodiment

### 2.1. System Configuration Example

First, a first embodiment of the present invention will be described. The first embodiment assumes a case where a control device 20 installed in a mobile object V controls whether to execute a function related to the mobile object V when a legitimate user of the mobile object V (such as an owner of the mobile object V or a person allowed to use the mobile object V) tries to execute the function. For example, the mobile object V may be a vehicle or the like.

Specifically, the control device 20 may control execution of the function related to the mobile object V in the case where both authenticity of the user and authenticity of a possession carried by the user are confirmed.

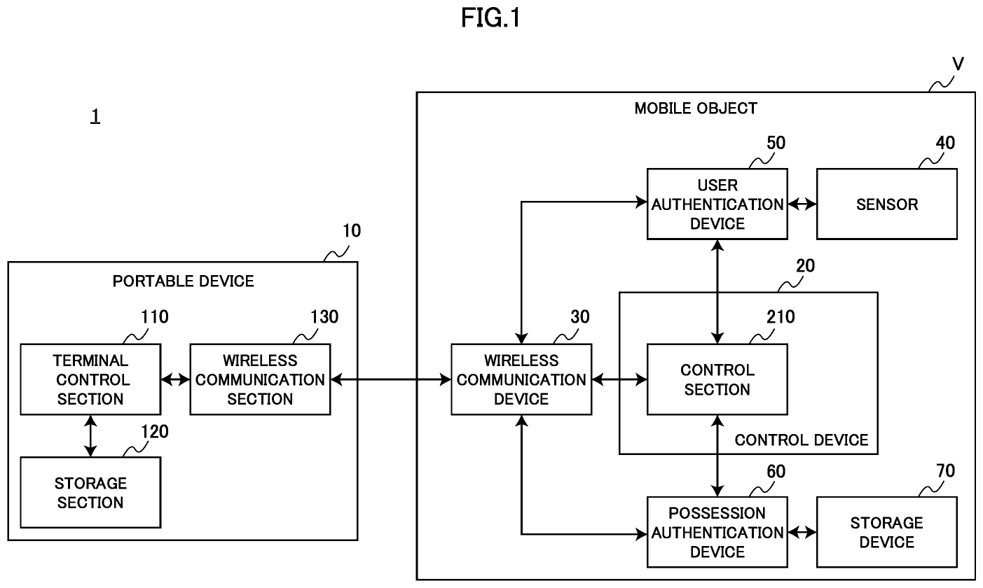

FIG. 1 is a diagram illustrating a configuration example of a system 1 according to the first embodiment of the present invention. As illustrated in FIG. 1, the system 1 according to the present embodiment includes structural elements installed in the mobile object V and a portable device 10.

(Portable Device 10)

The portable device 10 according to the present embodiment is an example of the possession carried by the user. For example, the portable device 10 may be an electronic key, a smartphone, a tablet, a wearable device, or the like. As illustrated in FIG. 1, the portable device 10 according to the present embodiment includes a terminal control section 110, a storage section 120, and a wireless communication section 130.

(Terminal Control Section 110)

The terminal control section 110 according to the present embodiment controls various functions of the portable device 10. For example, the terminal control section 110 may control wireless communication between the wireless communication section 130 and a wireless communication section 30 included in the mobile object V. In addition, the terminal control section 110 may perform control related to ranging that uses the wireless communication. The function of the terminal control section 110 may be implemented by cooperation of a processor such as a central processing unit (CPU), software, read only memory (ROM), random access memory (RAM), or the like.

(Storage Section 120)

The storage section 120 according to the present embodiment stores various kinds of information related to the portable device 10 and the like. For example, the storage section 120 stores identification information (hereinafter, referred to as second information) to be used for identifying the portable device 10 when a possession authentication device 60 of the mobile object V authenticates the possession. In addition, the storage section 120 stores third information to be used by a user authentication device 50 of the mobile object V to authenticate the user. Details of the second information and the third information will be described later.

(Wireless Communication Section 130)

The wireless communication section 130 according to the present embodiment performs wireless communication with a wireless communication device 30 of the mobile object V under the control of the terminal control section 110. For example, the wireless communication section 130 may perform communication with the wireless communication device 30 in conformity with a first wireless communication standard, and may transmit the above-described second information and third information to the wireless communication device 30. Note that, in conformity with the first wireless communication standard, a low frequency (LF) band signal and an ultra high frequency (UHF) band signal may be used, for example.

In addition, the wireless communication section 130 may perform communication in conformity with a second wireless communication standard, and may perform ranging for measuring a distance to the wireless communication device 30 through the communication. The second wireless communication standard is different from the first wireless communication standard. In conformity with the second wireless communication standard, a signal of an ultra-wideband (UWB) frequency may be used. In this case, it is possible to measure air propagation time of a radio wave with high accuracy by using a radio wave of ultra-short pulse width of a nanosecond or less, and it is possible to perform positioning and ranging with high accuracy on the basis of the propagation time.

On the other hand, the first wireless communication standard and the second wireless communication standard according to the present embodiment are not limited the examples described above. The first wireless communication standard according to the present embodiment may be various kinds of communication standards that make it possible to transmit and receive the second information and the third information. In addition, the second wireless communication standard according to the present embodiment may be various kinds of communication standards that make it possible to perform ranging with regard to a distance between the wireless communication section 130 and the wireless communication device 30.

(Mobile Object V)

The mobile object V is an example of a control target according to the present embodiment. As illustrated in FIG. 1, the mobile object V according to the present embodiment may include the control device 20, the wireless communication device 30, a sensor 40, the user authentication device 50, the possession authentication device 60, and a storage device 70.

(Control Device 20)

The control device 20 according to the present embodiment includes a control section 210 configured to control a designated function on the basis of authenticity of the user and authenticity of the possession carried by the user. Examples of the possession include the portable device 10. In addition, one of features of the control section 210 according to the present embodiment is to control execution of the designated function in the case where the authenticity of the user is confirmed on the basis of first information that the sensor 40 has acquired while the user is treated as a detection target and the authenticity of the possession is confirmed on the basis of the second information that the wireless communication device 30 has acquired from the possession through wireless communication.

In other words, the control section 210 according to the present embodiment is allowed to control execution of the designated function related to the mobile object

V in the case where it is confirmed that the legitimate user of the mobile object V is carrying the portable device 10, which is a legitimate possession. Examples of the designated function include unlocking of a door of the mobile object V, starting of an engine, and the like, for example.

For example, in the case of authenticating only the user by using information acquired by the sensor, sometimes the system may misidentify a third person as the legitimate user when various kinds of features related to the legitimate user such as a fingerprint, voice, or shape of his/her face is forged. On the other hand, by using a control method according to the present embodiment, it is possible to certainly prevent the third person from improperly operating the mobile object V as long as the portable device 10 is not carried by the third person even if the feature of the legitimate user is forged.

In addition, for example, in the case of authenticating only the possession by using information acquired from the portable device 10, there is a possibility that the mobile object V can be operated by a third person who has improperly acquired the portable device 10 or a third person who has improperly relayed a signal transmitted from the portable device 10. On the other hand, by using the control method according to the present embodiment, it is possible to determine that the third person is not the legitimate user and prevent abuse and the like of the mobile object V on the basis of the first information acquired while the third person is treated as the detection target, even in the case where the third person is carrying the portable device 10 or even in the case where the third person is relaying the signal transmitted from the portable device 10.

Note that, the function of the control section 210 may be implemented by cooperation of a processor such as a central processing unit (CPU), software, read only memory (ROM), random access memory (RAM), or the like.

(Wireless Communication Device 30)

The wireless communication device 30 according to the present embodiment performs wireless communication with the portable device 10. For example, the wireless communication device 30 performs communication in conformity with the first wireless communication standard described above, and acquires the second information or the third information from the portable device 10. In addition, for example, the wireless communication device 30 performs communication in conformity with the second wireless communication standard described above, and performs ranging for measuring a distance to the portable device 10.

(Sensor 40)

The sensor 40 according to the present embodiment is installed in the mobile object V together with the control device 20 and other devices, and acquires the first information while treating the user as the detection target. The mobile object V is the control target. The first information according to the present embodiment may be biological information of the user, for example.

Note that, the biological information according to the present embodiment widely includes various kinds of information obtained by digitizing physical features and behavioral features of the user. Examples of the biological information according to the present embodiment include an image that captures the physical feature such as a whole body, a face, a retina, an iris, a hand shape, a fingerprint, or veins of the user, a feature extracted from the image, and the like. In addition, for example, the biological information according to the present embodiment may be voice spoken by the user or a feature of voiceprint extracted from the spoken voice. In addition, the biological information according to the present embodiment may be an image that captures behavior of the user such as a gait, handwriting, or a predetermined gesture, or a feature extracted from the image.

(User Authentication Device 50)

The user authentication device 50 according to the present embodiment is a device of determining the authenticity of the user on the basis of comparison between the first information acquired by the sensor 40 and the third information acquired by the wireless communication device 30 through the wireless communication.

The third information according to the present embodiment may be information regarding the legitimate user who is assumed to carry the possession according to the present embodiment. Note that, examples of the above-described legitimate user include an owner of the possession according to the present embodiment, a person who is temporarily borrowing the possession according to the present embodiment, and the like. In addition, more specifically, the third information according to the present embodiment may be biological information of a similar type to the first information. The biological information is acquired from the legitimate user in advance.

In other words, the user authentication device 50 according to the present embodiment may compare the first information and the third information and may confirm the authenticity of the user in the case where similarity between the first information and the third information exceeds a designated threshold. The first information is biological information that the sensor 40 has acquired from the user in real time. The third information is a similar type of biological information that the wireless communication device 30 has acquired from the user in the past through the wireless communication.

Note that, according to the first embodiment of the present invention, the third information is stored in the storage section 120 of the portable device 10.

(Possession Authentication Device 60)

The possession authentication device 60 according to the present embodiment is a device of determining the authenticity of the possession on the basis of the second information that the wireless communication device 30 has acquired from the possession such as the portable device 10 through the wireless communication. The second information according to the present embodiment may be various kinds of information to be used for identifying the portable device 10 when the possession authentication device 60 authenticates the possession.

Examples of the second information according to the present embodiment include an identifier of the portable device 10, a password, and the like. In this case, the possession authentication device 60 determines whether or not the second information acquired by the wireless communication device 30 matches the password or identification information of the possession stored in the storage device 70. In the case where they match each other, the possession authentication device 60 is allowed to confirm the authenticity of the possession.

In addition, the examples of the second information according to the present embodiment include a result of computation carried out by the portable device 10 using a designated algorithm and data such as random numbers transmitted from the wireless communication device 30, and the like. In this case, the possession authentication device 60 determines whether or not the second information acquired by the wireless communication device 30 matches the computation result based on the algorithm stored in the storage device 70 and the data transmitted from the wireless communication device 30. In the case where they match each other, the possession authentication device 60 is allowed to confirm the authenticity of the possession.

(Storage Device 70)

The storage device 70 according to the present embodiment stores various kinds of data to be used by the possession authentication device 60 to make a determination. For example, the storage device 70 stores the identifier of the portable device 10, the password, the designated algorithm, and the like.

The configuration example of the system 1 according to the present embodiment has been described above. Note that, the configuration described above with reference to FIG. 1 is a mere example. The configuration of the system 1 according to the present embodiment is not limited thereto. For example, the control device 20 according to the present embodiment may be a device that implements both the function of the user authentication deice 50 and the function of the possession authentication device 60. The configuration of the system 1 according to the present embodiment may be flexibly modified in accordance with specifications and operations.

### 2.2. Flow of Operation

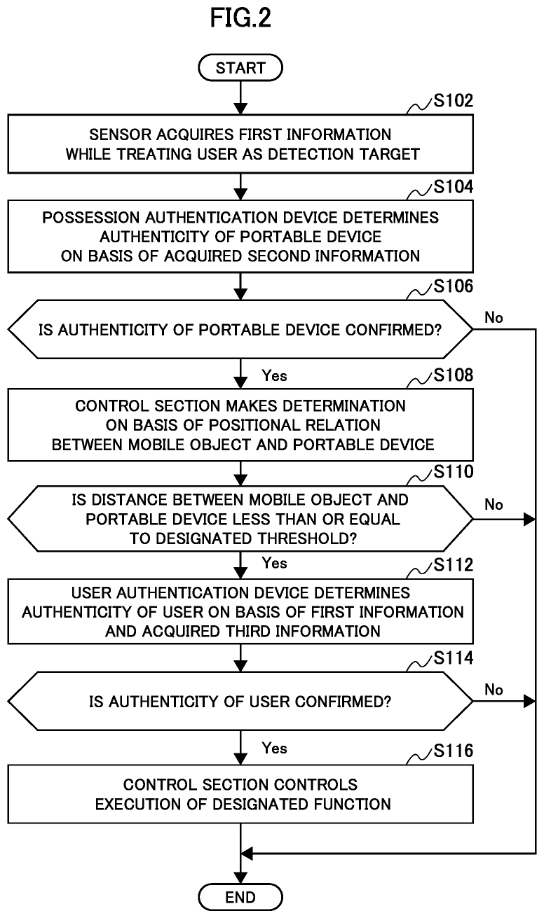

Next, a flow of operation of the system 1 according to the first embodiment of the present invention will be described in detail. FIG. 2 is a flowchart illustrating an example of the flow of the operation of the system 1 according to the present embodiment. Note that, exemplified here is a case of performing control as the designated function in such a manner that a door of the mobile object V will be unlocked to make the door openable only in the case where the control device 20 confirms legitimateness of the user and the portable device 10 when the user carries out operation of opening the door, will be described as an example.

As illustrated in FIG. 2, the sensor 40 first acquires the first information while treating the user as the detection target (S102).

Here, for example, the sensor 40 may be installed in a door handle of the mobile object V in the case where the first information and the third information are information related to a fingerprint of the user. In this case, it is possible to acquire the first information when the user carries out operation of opening the door. Therefore, the user does not have to carry out additional operation of inputting the first information. This makes it possible to improve operability.

In addition, for example, in the case where the first information and the third information are information related to the face or gait of the user, the sensor 40 may be installed inside or outside a vehicle interior of the mobile object V in such a manner that the sensor 40 is capable of capturing an image of the face or gait of the user who is approaching the door. Also in this case, the user does not have to carry out the additional operation of inputting the first information, and this makes it possible to improve operability.

Next, the possession authentication device 60 determines the authenticity of the portable device 10 on the basis of the second information that the wireless communication device 30 has received from the portable device 10 (S104). For example, the acquisition of the first information by the sensor 40 in Step S102 triggers the wireless communication device 30 to transmit a signal of requesting the second information to the portable device 10, and the determination in Step S104 may start when the second information is transmitted from the portable device 10 that has received the signal.

Here, in the case where the authenticity of the portable device 10 is not confirmed (No in Step S106), the control section 210 ends the process without instructing to unlock the door of the mobile object V.

On the other hand, in the case where the authenticity of the portable device 10 is confirmed (Yes in Step S106), the control section 210 may make a determination on the basis of a positional relation between the mobile object V and the portable device 10 (S108). More specifically, the control section 210 may determine whether or not a distance between the mobile object V and the portable device 10 is less than or equal to a designated threshold. For example, this makes it possible to perform control to unlock the door only in the case where the mobile portable device 10 is adjacent to the mobile object. It is possible to protect the mobile object V from an action of improperly relaying the signal transmitted from the portable device 10 and unlocking the door, and the like.

In this case, the distance between the mobile object V and the portable device 10 may be acquired through ranging that uses wireless communication between the wireless communication device 30 of the mobile object V and the wireless communication section 130 of the portable device 10.

For example, the distance is calculated from a time period ΔT1 from time when the wireless communication section 130 of the portable device 10 (or the wireless communication device 30) transmits a first ranging signal to time when the portable device 10 (or the wireless communication device 30) receives a second ranging signal, and a time period ΔT2 from time when the wireless communication device 30 (or the wireless communication section 130 of the portable device 10) receives the first ranging signal to time when the wireless communication device 30 (or the wireless communication section 130 of the portable device 10) transmits the second ranging signal.

More specifically, time taken to perform round-trip communication of the ranging signals is calculated by subtracting ΔT2 from ΔT1, and time taken to perform one-way communication of a ranging signal is calculated by dividing the calculated time by 2. In addition, by multiplying the value obtained through (ΔT1−ΔT2)/2 by speed of the signal, it is possible to calculate the distance between the portable device 10 and the mobile object V.

Here, in the case where the distance between the mobile object V and the portable device 10 exceeds a designated threshold (No in Step S110), the control section 210 ends the process without instructing to unlock the door of the mobile object V.

On the other hand, in the case where the distance between the mobile object V and the portable device 10 is less than or equal to the designated threshold (Yes in Step S110), the user authentication device 50 determines the authenticity of the user on the basis of the first information that the user authentication device 50 has acquired in Step S102 and the third information that the wireless communication device 30 has acquired from the portable device 10 (S112).

Here, in the case where the authenticity of the user is not confirmed (No in Step S114), the control section 210 ends the process without instructing to unlock the door of the mobile object V.

On the other hand, in the case where the authenticity of the user is confirmed (Yes in S114), that is, in the case where the authenticity of the user and the authenticity of the possession are confirmed and the distance between the mobile object V and the portable device 10 is less than or equal to the designated threshold, the control section 210 controls execution of the designated function (S116).

The example of the flow of the operation of the system 1 according to the present embodiment has been described above. Note that, with reference to FIG. 2, the case where the authenticity of the user and the authenticity of the possession are confirmed and the control section 210 controls execution of the designated function on the basis of the positional relation between the mobile object V and the portable device 10 has been exemplified. However, the determination is not necessarily made on the basis of the positional relation. On the other hand, for example, in the case where the ranging result indicates that the portable device 10 is outside the vehicle interior of the mobile object V, the designated function may allow the control section 210 to perform control to unlock the door. In the case where the portable device 10 is in the vehicle interior of the mobile object V, the designated function may allow the control section 210 to perform control to start the engine, for example.

In addition, the case where the acquisition of the first information by the sensor 40 triggers the wireless communication device 30 to transmit the signal of requesting the second information to the portable device 10 has been exemplified above. However, this is a mere example. The acquisition of the first information, the determination of the authenticity of the user, the acquisition of the second information, the determination of the authenticity of the portable device 10, the ranging, and the determination based on the positional relation obtained from a result of the ranging according to the present embodiment may be carried out in a different order from the order illustrated in FIG. 2, or may be carried out in parallel.

### 3. Second Embodiment

### 3.1. System Configuration Example

Next, a second embodiment of the present invention will be described. The above-described first embodiment has assumed the case where the mobile object V is continuously used by a specific user such as an individual or a company. However, in recent years, sometimes the mobile object V is temporarily used by many and unspecified users due to widespread use of services such as a car rental and carsharing. However, in this case, a period of use of the mobile object V or the like is limited. Therefore, it is necessary to impose a specific limitation on information to be used for determining the authenticities.

The second embodiment of the present invention was conceived by focusing on the above-described points. According to the second embodiment, it is also possible for a user who temporarily uses the mobile object V to use the second information in a service such as a car rental or carsharing by distributing the second information on which the specific limitation is imposed to the portable device 10.

Therefore, a system 1 according to the second embodiment of the present invention further includes a server 80 in addition to the structural elements illustrated in FIG. 2. The server 80 distributes the second information on which the specific limitation is imposed to the portable device 10. Next, functions of the server according to the present embodiment will be described in detail. Note that, hereinafter, a description will be given while focusing on a difference between the first embodiment and the second embodiment, and repeated explanation will be omitted with regard to structural elements, functions, effects, and the like that are common to the first embodiment and the second embodiment.

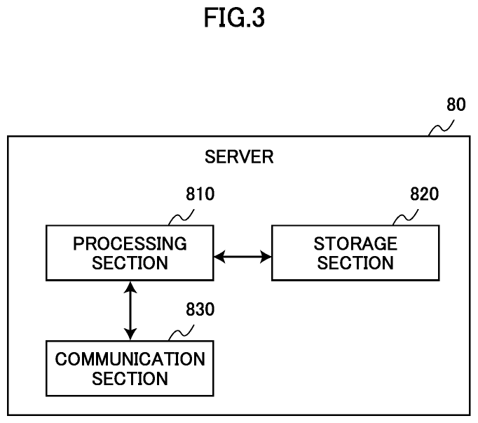

FIG. 3 is a diagram illustrating a configuration example of the server 80 according to the second embodiment of the present invention. As illustrated in FIG. 3, the server 80 according to the present embodiment may include a processing section 810, a storage section 820, and a communication section 830.

(Processing Section 810)

The processing section 810 according to the present embodiment has a function of generating the second information on which the specific limitation is imposed, and transmitting the second information to the portable device 10 via the communication section 830. The portable device 10 is owned by a user who is allowed to temporarily use the mobile object V.

For example, the specific limitation includes a limitation for designating a time period in which the second information (identification information) is valid. For example, the processing section 810 may generate the second information on which a limitation is imposed in such a manner that the second information is valid only in a time period reserved by the user to use the mobile object V in a service such as a car rental or carsharing.

In addition, the processing section 810 generates information (hereinafter, referred to as pair information) that is distributed to the portable device 10 and that is necessary for the possession authentication device 60 to identify the portable device 10 by using the second information transmitted from the portable device 10 to the wireless communication device 30, and the processing section 810 transmits the generated pair information to the wireless communication device 30 via the communication section 830. Note that, the pair information may be information equivalent to various kinds of information that is stored in the storage device 70 and that is to be used by the possession authentication device 60 for authentication. Such information has been exemplified in the first embodiment.

(Storage Section 820)

The storage section 820 according to the present embodiment stores reservation information related to the mobile object V and information related to the user and the portable device 10 owned by the user.

(Communication Section 830)

The communication section 830 according to the present embodiment performs information communication with the wireless communication device 30 of the mobile object V and the portable device 10 under the control of the processing section 810. For example, the information communication may be performed via the Internet or the like. For example, the communication section 830 transmits the second information to the portable device 10. The second information is generated by the processing section 810, and the specific limitation is imposed on the second information. In addition, for example, the communication section 830 transmits the pair information generated by the processing section 810 to the wireless communication device 30 of the mobile object V.

The configuration example of the server 80 according to the second embodiment of the present invention has been described above. Note that, the configuration described above with reference to FIG. 3 is a mere example. The configuration of the server 80 is not limited thereto. For example, the server 80 may have a function of managing reservation for use of the mobile object V by using the portable device 10. The configuration of the server 80 may be flexibly modified in accordance with specifications and operations.

### 3.2. Flow of Operation

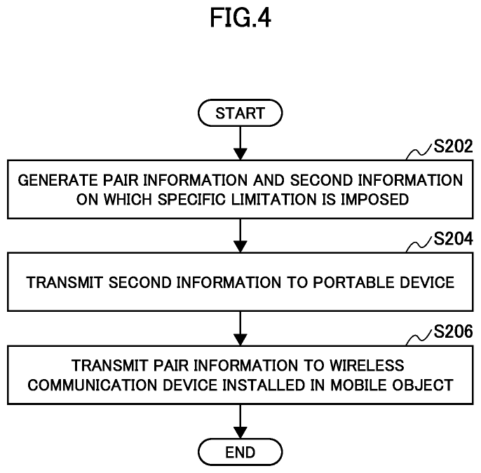

Next, a flow of operation of the server 80 according to the present embodiment will be described in detail. FIG. 4 is a flowchart illustrating an example of the flow of the operation of the server 80 according to the present embodiment.

As illustrated in FIG. 4, the processing section 810 first generates the second information on which the specific limitation is imposed, and the pair information for identifying the portable device 10 by using the second information (S202). The processing section 810 may generate the second information on which the specific limitation is imposed and the pair information on the basis of the reservation information related to the mobile object V. The reservation information is stored in the storage section 820.

Next, the communication section 830 transmits the second information on which the specific limitation generated in Step S202 is imposed, to the portable device 10 under the control of the processing section 810 (S204).

In addition, the communication section 830 transmits the pair information generated in Step S202, to the wireless communication device of the mobile object V under the control of the processing section 810 (S206).

### 4. Third Embodiment

### 4.1. Flow of Operation

Next, a third embodiment of the present invention will be described. According to the third embodiment of the present invention, the server 80 extracts a feature amount from information related to the user such as the biological information acquired by the portable device 10, and generates information obtained by encrypting the feature amount as the third information.

Note that, hereinafter, a description will be given while focusing on differences from the first embodiment and the second embodiment, and repeated explanation will be omitted with regard to structural elements, functions, effects, and the like that are common to the first embodiment, the second embodiment, and the third embodiment.

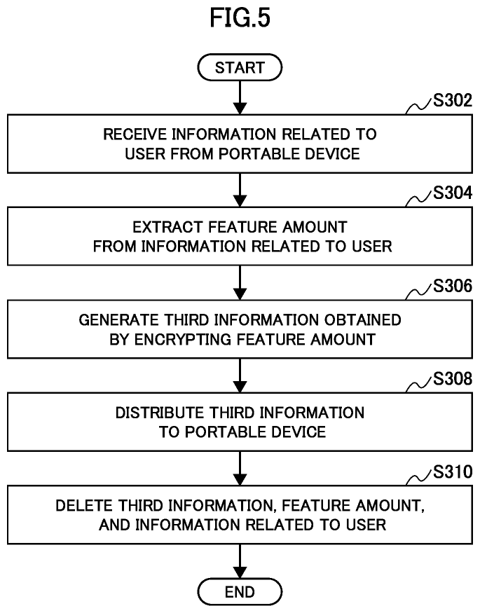

FIG. 5 is a flowchart illustrating an example of a flow of operation of the server 80 according to the third embodiment of the present invention.

According to the third embodiment of the present invention, the communication section 830 first receives information related to the user such as the biological information from the portable device 10 (S302). For example, the information related to the user may be an image of the face of the user captured by a camera of the portable device 10 or the like.

Next, the processing section 810 extracts the feature amount from the information related to the user (S304). The information related to the user is received by the communication section 830 in Step S302.

Next, the processing section 810 encrypts the feature amount extracted in Step S304 by using an encryption key shared with all the mobile objects V in advance, and generates the third information (S306).

Next, the communication section 830 transmits the third information generated in Step S306, to the portable device 10 under the control of the processing section 810 (S308). Under such control, the feature amount encrypted as the third information is transmitted from the portable device 10 to the wireless communication device 30 of the mobile object V, and plaintext of the third information is obtained only when the user authentication device 50 determines the authenticity. This makes it possible to achieve a mechanism that is more resistant to information leakage.

In addition, after the third information is transmitted in Step S308, it is possible for the processing section 810 to delete the third information, the feature amount, and the information related to the user, which are stored in the storage section 820 (S310). Under such control, it is possible to reduce load without causing a shortage of storage capacity of the storage section 820.

### 5. Modifications

Next, other modifications will be described. According to the first to third embodiments, the user authentication device 50 of the mobile object V determines the authenticity of the user. However, the portable device 10 or the server 80 may determine the authenticity of the user on the basis of the first information and the third information.

For example, the terminal control section 110 of the portable device 10 may determine the authenticity of the user by acquiring the first information from the sensor 40 via the wireless communication device 30 and comparing the first information with the third information stored in the storage section 120. In this case, the terminal control section 110 transmits a result of the determination to the wireless communication device 30 via the wireless communication section 130. Even in this case, it is possible for the control section 210 of the control device 20 to control the designated function on the basis of the authenticity of the user and the authenticity of the possession.

In a similar way, the processing section 810 of the server 80 may determine the authenticity of the user by acquiring the first information from the sensor 40 via the wireless communication device 30 and comparing the first information with the third information stored in advance in the storage section 820. In this case, the processing section 810 transmits a result of the determination to the wireless communication device 30 via the communication section 830. Even in this case, it is possible for the control section 210 of the control device 20 to control the designated function on the basis of the authenticity of the user and the authenticity of the possession.

On the other hand, as described above with regard to the first to third embodiments, the third information may be stored in the storage device 70 of the mobile object V in the case where the user authentication device 50 of the mobile object V determines the authenticity of the user on the basis of the first information and the third information. In this case, the user authentication device 50 makes the determination by getting connected to the storage device 70 and acquiring the third information from the storage device 70.

In addition, depending on a setting configured by the user, it is possible to omit the determination of the authenticity of the user based on the first information and the third information. For example, the user may set whether or not to omit the determination of the authenticity of the user by operating the portable device 10. In this case, the terminal control section 110 may transmit information indicating whether or not to omit the determination of the authenticity of the user (for example, a 1-bit value of “1” or “0”) by including the information into the second information.

### 6. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

Note that, the series of processes performed by the devices described in this specification may be achieved by any of software, hardware, and a combination of software and hardware. A program that configures software is stored in advance in, for example, a recording medium (non-transitory medium) installed inside or outside the devices. In addition, for example, when a computer executes the programs, the programs are read into RAM, and executed by a processor such as a CPU. The recording medium may be a magnetic disk, an optical disc, a magneto-optical disc, flash memory, or the like, for example. Alternatively, the above-described computer program may be distributed via a network without using the recording medium, for example.

### REFERENCE SIGNS LIST

10 portable device
110 terminal control section
120 storage section
130 wireless communication section
20 control device
210 control section
30 wireless communication device
40 sensor
50 user authentication device
60 possession authentication device
70 storage device
80 server
810 processing section
820 storage section
830 communication section

What is claimed is:

1. A control device comprising
a control section configured to control a designated function on a basis of authenticity of a user and authenticity of a possession carried by the user,
wherein the control section controls execution of the designated function in a case where the authenticity of the user is confirmed on a basis of first information acquired while the user is treated as a detection target and the authenticity of the possession is confirmed on a basis of second information acquired from the possession through wireless communication.

2. The control device according to claim 1,
wherein the second information is identification information to be used for identifying the possession.

3. The control device according to claim 1,
wherein the control section controls execution of the designated function in a case where the authenticity of the user is confirmed on a basis of comparison between the first information and third information acquired through wireless communication.

4. The control device according to claim 3,
wherein the third information is information regarding a legitimate user who is assumed to carry the possession.

5. The control device according to claim 1,
wherein the first information includes biological information acquired from the user.

6. The control device according to claim 1, wherein
the first information is acquired by a sensor installed in a control target in which the control device is also installed, and
the control section controls execution of the designated function related to the control target in a case where the authenticity of the user and the authenticity of the possession carried by the user are confirmed.

7. The control device according to claim 1,
wherein the second information is identification information that is distributed to the possession and that is to be used for identifying the possession, and the second information is information on which a specific limitation is imposed.

8. The control device according to claim 7,
wherein the specific limitation includes a limitation for designating a time period in which the identification information is valid.

9. The control device according to claim 1,
wherein the control section controls the designated function related to a control target in which the control device is installed, further on a basis of a positional relation between the possession and the control target.

10. The control device according to claim 9,
wherein the control section controls execution of the designated function in a case where a distance between the control target and the possession is less than or equal to a designated threshold.

11. The control device according to claim 10,
wherein the distance between the control target and the possession is acquired through ranging that uses wireless communication between the possession and a wireless communication device installed in the control target.

12. A control device that is installed in a mobile object, the control device comprising
a control section configured to control a designated function related to the mobile object, on a basis of authenticity of a user and authenticity of a possession carried by the user,
wherein the control section controls execution of the designated function related to the mobile object, in a case where the authenticity of the user is confirmed on a basis of first information acquired by a sensor installed in the mobile object while the user is treated as a detection target and the authenticity of the possession is confirmed on a basis of second information acquired from the possession through wireless communication.

13. A system comprising:
a possession configured to be carried by a user;
a control device configured to control a designated function related to a control target, on a basis of authenticity of the user and authenticity of the possession; and
a sensor configured to be installed in the control target and acquire first information while the user is treated as a detection target,
wherein the control device controls execution of the designated function in a case where the authenticity of the user is confirmed on a basis of the first information and the authenticity of the possession is confirmed on a basis of second information acquired from the possession through wireless communication.
